(19) United States
(12) Patent Application Publication
(10) Pub. No.: US 2025/0309722 A1
(43) Pub. Date: Oct. 2, 2025

(54) WELDED HIGH-CURRENT CONNECTIONS IN DYNAMOELECTRIC MACHINES

(71) Applicant: Innomotics GmbH, 90441 Nürnberg (DE)

(72) Inventors: JOHANNES RICHTER, Fürth (DE); CHRISTIAN WEIDERMANN, Pössneck (DE)

(73) Assignee: Innomotics GmbH, 90441 Nürnberg (DE)

(21) Appl. No.: 18/864,450

(22) PCT Filed: Apr. 20, 2023
(86) PCT No.: PCT/EP2023/060219

§ 371 Date: Nov. 8, 2024

(30) Foreign Application Priority Data
May 11, 2022 (EP) 22172786.0

(51) Int. Cl. H02K 3/50; H02K 11/33; H02K 15/32; H02K 17/16

(52) U.S. Cl. CPC H02K 3/505; H02K 11/33; H02K 15/32; H02K 17/168

(57) ABSTRACT

A rotary dynamoelectric machine includes a stator with a winding system arranged in a magnetically conductive element and including bar-shaped conductors arranged in grooves of the magnetically conductive element. Each conductor protrudes with a first end from a groove on an end face side of the magnetically conductive element. A connecting element connects to the first end of the conductor, and a contact element with a stud establishes an electrically low-impedance contact between the first end of the conductor and the connecting element to an inverter module, or a contact stud is designed for extension via a female/male contact to a further contact stud for contacting the connecting element so as to enable a connection of a plurality of inverter modules axially behind one another to the connecting element. A short circuit ring combines a second end of the conductors on another end face side of the magnetically conductive element.

The invention relates to a dynamoelectric machine of which the winding system is electrically contacted with inverter modules, as well as to a method for manufacturing such a dynamoelectric machine, in particular a stator with a contacting method.

Winding systems, i.e. wires or bar-shaped conductors in grooves of a stator of a dynamoelectric machine, are connected via solder connections or crimp connections, preferably via a terminal box, to the electrical network or to outputs of an inverter.

This stator winding system usually consists of wound coils with single wires, stranded conductors or bar-shaped conductors, which are then connected to form an electrical winding system.

With comparatively powerful dynamoelectric machines (>500 KW) external inverters (for example a large switching cabinet in a separate room) supply this machine with comparatively low current and comparatively high voltage by means of rigid, thick and insulated lines.

Because of the usually high voltage level for power transmission between inverter and machine it is necessary to provide insulation.

For the currents to be transmitted the said connection techniques, such as crimp sleeves or solder connections, are provided for establishing contact.

On this basis, the underlying object of the invention is to provide a contacting apparatus and a contacting method for a dynamoelectric machine in order to transmit comparatively high currents from an inverter module into the winding system of the dynamoelectric machine almost without losses.

The desired object is successfully achieved by a rotary dynamoelectric machine with a stator, which has a winding system in a magnetically conductive element, and a rotor, wherein stator and rotor are separated from one another by an air gap, wherein the first end of a bar-shaped conductor on an end face of the magnetically conductive element of the stator projecting from a groove is provided with at least one connecting element that establishes an electrically low-impedance contact between the first end of the bar-shaped conductor and at least one connecting element and/or an electrically low-impedance contact between the connecting element and at least one inverter module.

The desired object is also successfully achieved by a method for manufacturing a stator of a rotary dynamoelectric machine, which has a winding system in a magnetically conductive element, by the following steps:
manufacturing a magnetically conductive element, in particular a laminated core of the stator,
establishing contact with at least one connecting element at a first axial end of a bar-shaped conductor of a groove in each case,
axial insertion of the bar-shaped conductors provided with the connecting elements into the respective grooves of the laminated core or magnetically conductive element,
establishing contact with at least one short circuit ring at the second ends of the bar-shaped conductors,
axial placement of the inverter modules on the connecting elements in contact with the bar-shaped conductor and establishing contact by means of contact elements between these connecting elements and the inverter modules provided.

In this case a first end of a bar-shaped conductor is electrically contacted with at least one inverter module by means of a special welding method, in particular the contacting is undertaken using a butt joint welded connection. In the method a connecting element is electrically contacted with the first end of a bar-shaped conductor that protrudes axially from the groove of the stator.

A butt joint welded connection is understood as a welded connection in which electrical contact is made between the end face sides of massive elements, wires, studs, stranded conductors, in this case with a connecting element.

These assemblies to be connected are fixed in this case into the clamping apparatus, for example clamping chucks, which are specifically adapted to the geometry of the parts to be welded. The clamp connection represents a mechanical clamped support and fixes and establishes contact between the joining members electrically for the welding process by means of heavy current.

The fact that the joining members are pressed against one another means that a good contact is formed over the entire cross-sectional surface to be contacted. Through the flow of current the overall points of contact are simultaneously heated up to welding temperature (melted). When the required temperature is reached over the entire weld cross-sectional surface, depending on the method, the flow of current is interrupted and the assemblies are pressed firmly onto one another by means of a forwards movement of the electrodes.

Resistance butt welding is characterized as a result by a burr-free thick seam. For an optimal welding result the assemblies to be welded, i.e. the massive parts, wires, or stranded conductors and the connecting element, must be clean at the joint, provided the insulation material is an inorganic and non-combustible material. Other insulation materials, such as epoxy resins or plastics, do not have to be removed, these burn away during butt joint welding, so are then free from an insulation material.

In principle crimp and solder connections are also conceivable for these high operational current strengths of the dynamoelectric machine. With crimp connections however the associated sleeves are comparatively large and likewise the tools needed for this process, so that a compact structure and/or access can be rendered more difficult. With soldering processes the strength of the contact joint and access to the solder point is to be guaranteed.

Via the connecting element the inverter modules feed the operating current into the bar-shaped conductor that is arranged in a groove of the stator.

This high-current connection between the first end of the bar-shaped conductor and a connecting element is pre-installed and welded before the axial insertion into the groove. Contact is only established with the inverter module when the bar-shaped conductor with its connecting element is positioned in the magnetically conductive element, in particular the laminated core of the stator.

The joining members—i.e. bar-shaped conductor or partial conductors of this bar-shaped conductor and the connecting element or elements are fixed in this case during the welding process by specially adapted clamping jaws or clamping chucks.

The insulation material at the first ends of the bar-shaped conductors must be removed in this case at the coupling point or at the later contact region between connecting element and first end of the bar-shaped conductor for the welding current.

The inventive method enables various geometric embodiments and conductor materials of the bar-shaped conductors to be connected to one another in a space-saving and low-impedance manner.

The transfer impedance or contact impedance in the connection point between connecting element and the first end of the bar-shaped conductor-i.e. between the joining members—is comparatively low in this case and the connecting point is compact in its design so that, even with a plurality of connection points on an end face side of the dynamoelectric machine, a compact structure with the inverter modules is made possible.

In other words:

One bar-shaped conductor is provided per groove, which has a connecting element and thus enables one or more inverter modules to feed power into this bar-shaped conductor.

A bar-shaped conductor can likewise be divided into a number of partial conductors per groove, so that a number of connecting elements per groove are provided, wherein in this case one or more inverter modules feed into the respective partial conductor or conductors of this bar-shaped conductor.

In other words, a bar-shaped conductor that is constructed from a predeterminable number of partial conductors (twisted or untwisted), can be divided into a number of subgroups, wherein each subgroup is able to be assigned electrically to one or more inverter modules and in particular is able to be contacted by a butt joint weld connection. Thus also just one partial conductor can be assigned to an inverter module. The partial conductors per groove, because of the low voltage levels, are not provided with a layer of insulation or are provided with a comparatively small layer of insulation.

At the other end, i.e. the second end of the bar-shaped conductors, these are combined with one another to form a short circuit ring, i.e. electrically contacted via the short circuit ring. This occurs at the earliest when all the bar-shaped conductors with their connecting elements have been inserted axially into their respective grooves.

For these dynamoelectric machines with at least one integrated current converter or inverter at each first end of a bar-shaped conductor, an electrical configuration in the stator with low voltages (<100V) and high current strengths (>1000 A) is now possible in accordance with the invention.

Through the special winding concept of the stator, copper bars—embodied as massive conductors or as divided conductors—are used, so that coils with a winding number of 0.5 are produced. This means that the classical winding heads known per se are dispensed with on the end face sides of the magnetically conductive element or laminated cores. The axial loading of the stator is thus reduced and the dynamoelectric machine or the entire drive can thus be of a compact design,

The power electronics of the inverter modules are electrically bound to the bar-shaped conductors and thus comparatively high currents can be transferred almost loss-free. This enables the classical, comparatively high-impedance or expensive high-current connections such as crimped, soldered or screw connections to be avoided.

This transition is also suitable in particular from divided or stranded conductors to massive elements of the connecting elements, made of copper for example.

The specific welding method, in particular together with the connecting elements, creates a comparatively small transfer impedance and thus lower losses at these contact points. This thus increases the efficiency of the rotary dynamoelectric machine and thus of the drive as a whole. Moreover the mechanical strength of the connection points or points of contact is improved and is thus more robust.

The butt joint welded connection makes possible individual geometries of the copper adapter welded to the conductors. Because of the geometrical degree of freedom obtained by this, the integrated power electronics or inverter modules are able to be linked in a space-saving manner without needing additional space and arranged on the end face side of the stator.

Because of the advance contacting of the connecting elements with the bar-shaped conductor, savings are made in installation time of the dynamoelectric machine, since this pre-installation takes place outside the machine. Any possible solder connections in the dynamoelectric machine are where necessary only required at the second ends of the bar-shaped conductors for embodying the short circuit ring on the other end face side of the stator.

This winding system by means of bar-shaped conductors leads, by doing away with complex winding methods, to a simpler final installation of the stator of the dynamoelectric machine and thus of the entire drive.

The invention, as well as further advantageous embodiments of the invention, are explained in greater detail with the aid of basic diagrams of exemplary embodiments, in which:

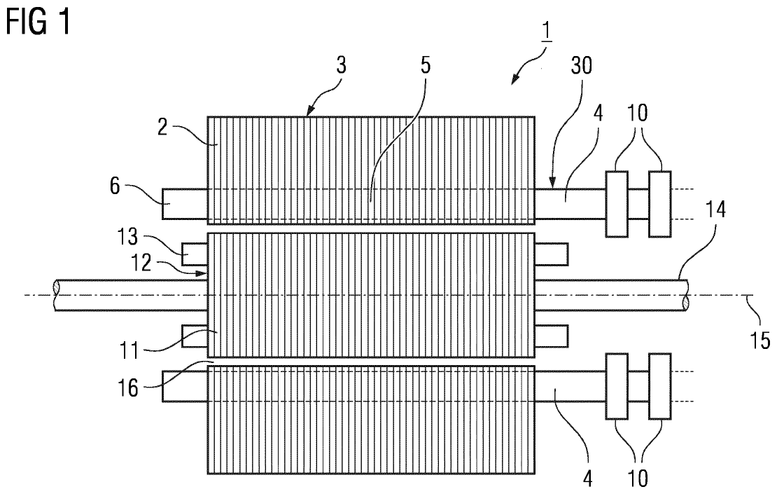

FIG. 1 shows a dynamoelectric machine,

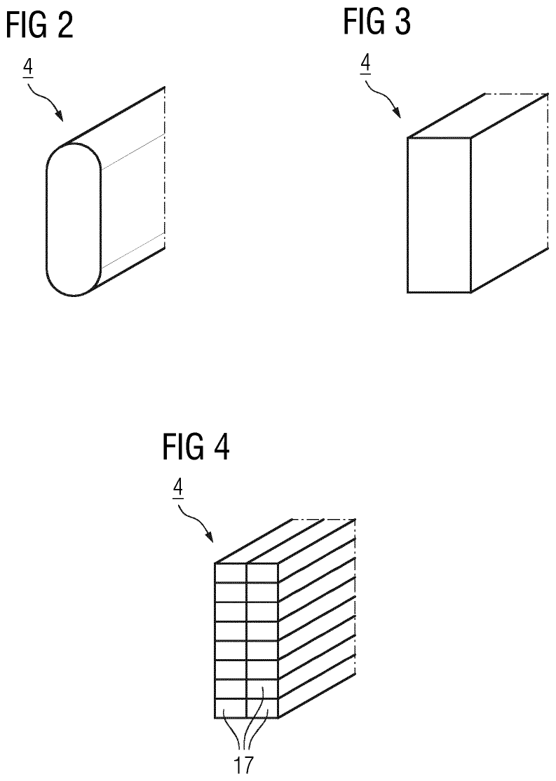

FIGS. 2 to 4 show possible bar-shaped conductors,

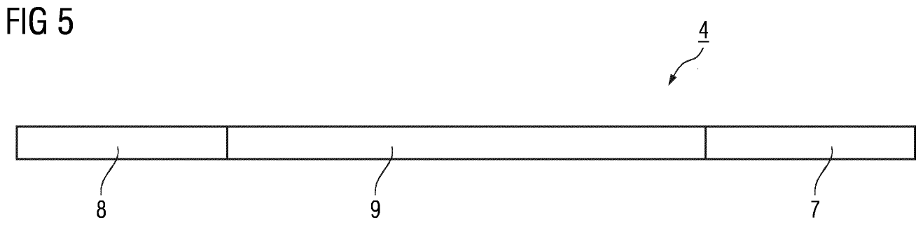

FIG. 5 shows axial division of a bar-shaped conductor,

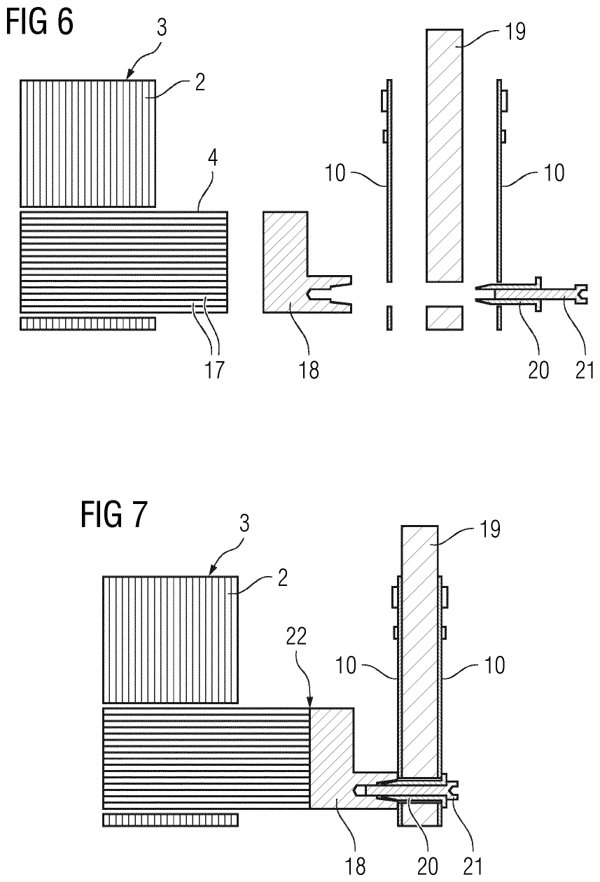

FIGS. 6, 7 show contacting of an inverter module at a bar-shaped conductor,

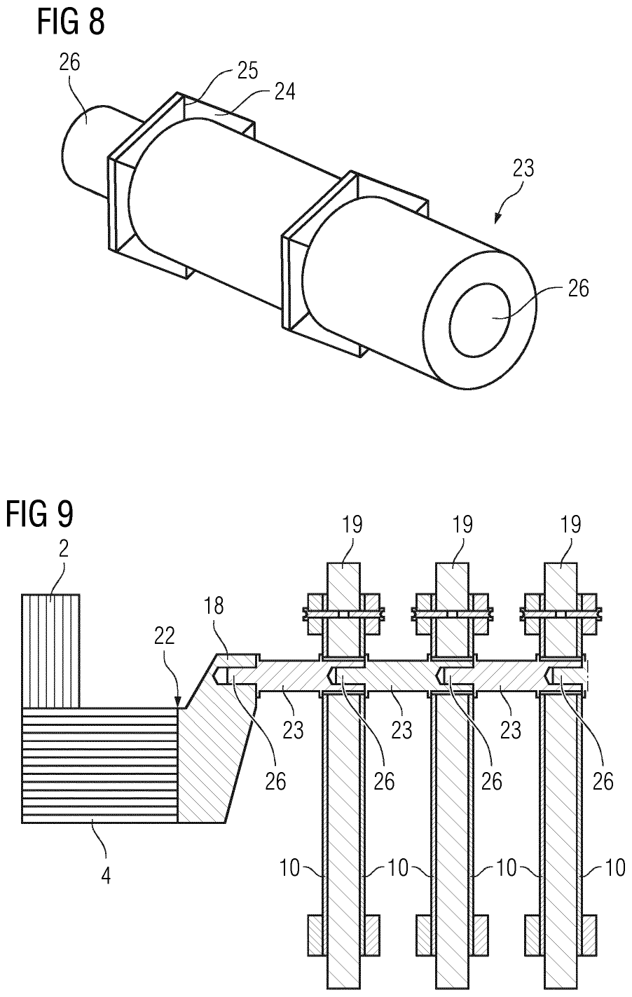

FIGS. 8, 9 show further contacting of inverter modules at a bar-shaped conductor,

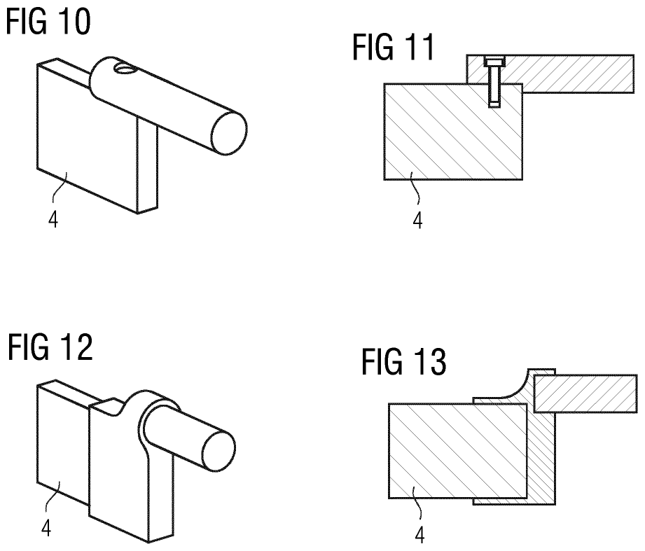

FIGS. 10 to 17 show possible embodiments and contact established between connecting element and bar-shaped conductor.

It should be pointed out that terms such as “axial”, “radial”, “tangential” etc. relate to the axis 15 used in the respective figure or in the respective example described. In other words the directions axial, radial, tangential always relate to an axis 15 of the rotor 12 and thereby to the corresponding axis of symmetry of the stator 3. In such cases “axial” describes a direction parallel to axis 15, “radial” describes a direction orthogonal to axis 15, towards this or away from it and “tangential” is a direction that is directed at a constant radial distance from axis 15 and with a constant axial position in the form of a circle around the axis 15. The expression “in the circumferential direction” is to be equated with “tangential”.

With regard to a surface, for example a cross-sectional surface, the terms “axial”, “radial”, “tangential” etc. describe the orientation of the normal vector of the surface, i.e. of that vector that is perpendicular to the surface concerned.

The expression “coaxial assemblies”, for example coaxial components, such as rotor 12 and stator 3, is understood here as assemblies that have the same normal vectors, thus for which the planes defined by the coaxial assemblies are parallel to one another, Furthermore the expression should mean that the center points of coaxial assemblies lie on the same axis of rotation or symmetry. These center points can however lie on this axis possibly at different axial positions and the said planes can thus be at a distance of >0 from one another. The expression does not necessarily demand that coaxial assemblies have the same radius.

The term “complementary” means in conjunction with two components that are “complementary” to one another, that their external shapes are designed in such a way that the one component can preferably be arranged completely in the component complementary to it, so that the inner surface of the one component and the outer surface of the other component are ideally touching each other without gaps or over their entire surface. Consequently, in the case of two objects complementary to one another, the external shape of the one object is thus defined by external shape of the other object. The term “complementary” could also be replaced by the term “inverse”.

For reasons of clarity, partly in the cases in which assemblies are present multiple times, not all assemblies shown are provided with reference numbers.

The embodiments described below can be combined in any way. Likewise, individual features of the respective embodiments are also able to be combined, without departing from the spirit of the invention.

FIG. 1 shows, in a basic diagram of a longitudinal section, a dynamoelectric machine 1, wherein a rotor 12, which is constructed from axially layered metal sheets, is designed as a squirrel cage rotor, which on the end face sides of the laminated core 11 has a short circuit ring 13 in each case. The laminated core 11 of the rotor 12 is connected in a torsion-proof manner to a shaft 14, which is supported rotatably about an axis 15. The rotor 12 is surrounded by a stator 3. Stator 3 and rotor 12 are spaced apart from one another by an air gap 16. The magnetically-conductive element of the stator 3 is likewise formed by a laminated core 2. Bar-shaped conductors 4, which on an end face side of the laminated core 2 form a short circuit ring 6, are arranged in grooves 5 of the laminated core 2 of the stator 3 that essentially run axially. On the other side of the laminated core 2 one or more inverter modules 10 is arranged in each case at the ends 7 of the first bar-shaped conductor.

In operation of the dynamoelectric machine 1 each bar-shaped conductor 4 can now be activated individually via its respective inverter module 10 or its inverter modules 10, so that the dynamoelectric machine 1 can be operated inter alia with a different number of pole pairs. Likewise, in the operation of the dynamoelectric machine 1, a change of the magnetic radial attraction can be set. Furthermore it is possible to react to vibrations of the dynamoelectric machine 1, and then to damp or avoid said vibrations by corresponding activation of the respective bar-shaped conductor 4.

The bar-shaped conductor 4, which is arranged in a groove 5 of the laminated core 2 of the stator 3 can be embodied for example in accordance with FIGS. 2 to 4. FIGS. 2 and FIG. 3 show a bar-shaped conductor 4 that is embodied in one piece, i.e. consists of one massive conductor. The bar-shaped conductors according to FIG. 2 and FIG. 3 have different cross-sectional shapes however in order to correspond to the respective cross-sectional shape of a groove 5.

FIG. 4 shows a bar-shaped conductor 4 by way of example, which is divided into partial conductors 17 running in parallel. This thus allows certain current displacement effects that arise with larger conductor cross sections to be avoided. Furthermore this type of conductor structure in accordance with FIG. 4 produces the option of activating a predeterminable number of partial conductors 17 of a bar-shaped conductor 4 via a separate inverter module 10.

In a further embodiment the partial conductors 17 of a bar-shaped conductor 4 are arranged twisted in the groove 5 in order to further reduce current displacement effects.

In other words, a bar-shaped conductor 4, which is constructed from a predeterminable number of partial conductors 17, can be divided into subgroups, wherein each subgroup is able to be assigned electrically to one or more inverter modules 10 and in particular is able to be contacted in accordance with the invention.

FIG. 5 shows a bar-shaped conductor 4 by way of example, which is divided into axial sections. A first axial end 7 of the bar-shaped conductor 4 is provided for contacting with the inverter module or inverter modules 10. The second axial end 8 of the bar-shaped conductor 4 on the other side of the laminated core 2 of the stator 3—i.e. on the opposite end face side—protrudes from the laminated core of the stator 3, and with other bar-shaped conductors 4, which protrude from the respective grooves 5, is provided with a short circuit ring 6. This short circuit ring 6 of the stator 3 can rest in this case directly on a laminated core 2 of the stator 3 or be arranged spaced apart from the laminated core 2 of the stator 3.

FIG. 6 shows an example of the components of a contact made between an inverter module 10 and a bar-shaped conductor 4. The bar-shaped conductor 4 (already arranged here in the groove 5 of the stator 3) is made up of partial conductors 17. Furthermore a connecting element 18 is provided that forms an adapter between the bar-shaped conductor 4 and the inverter module or inverter modules 10. The inverter module 10 is then electrically contacted by a contact element 20 and a stud 21 on the connecting element 18 at low impedance. The connecting element 18 is connected by a low-impedance electrical connection to the bar-shaped conductor 4, in particular to the partial conductors 17 of the bar-shaped conductor 4 assigned in each case. In this case butt joint welded connections are preferably provided for establishing contact between the bar-shaped conductor 4 and the connecting element 18.

FIG. 7 shows the contact in its assembled state, in this case between two inverter modules 10 and the connecting element 18 via the contact element 20. In order to obtain a sufficient low-impedance contacting the stud 21 is inserted into a corresponding cutout of the connecting element 18 and fixed.

In a further embodiment in accordance with FIG. 9 the inverter modules 10 are now contacted with the connecting element 18 by means of a contact stud 23 in accordance with FIG. 8. The contacting between the contact stud 23 and the connecting element 18 is successfully established via a female/male contact 26 and is moreover suitable for axial extension of this contact, so that a number of inverter modules 10 can be arranged axially after one another. This axial arrangement after one another of the inverter modules 10 serves, inter alia, to divide the power within the inverter modules 10 to each bar-shaped conductor 4 and also aims to provide redundancy.

Advantageously in this case cooling plates 19 are then arranged between the inverter modules 10.

FIG. 8 shows in a perspective diagram the contact stud 23 with circumferential webs 24, in which slits 25 are provided. The circumferential webs 24 form the contact surfaces to the individual inverter modules 10, which carry the current from inverter module 10 via the contact stud 23 and the connecting element 18 into the bar-shaped conductor 4. In order to obtain a sufficient contact between the webs 24 and the inverter module 10, slits 25 are provided in the webs 24. By the contact stud 23 having an axial cutout on one side, as is shown in principle in FIG. 9, a number of female/male contacts 26 can be arranged axially one after the other, in order to be able to connect a number of inverter modules 10 one after the other.

FIG. 10 and FIG. 11 show, in a perspective diagram and in a basic diagram of a longitudinal section, a further option for establishing contact between a conductor coming from the inverter module 10 and a bar-shaped conductor 4. In this case this occurs through a screw connection, which is preferably suitable for one-piece bar-shaped conductors 4.

FIG. 12 and FIG. 13 show, in a perspective diagram and in a basic diagram of a longitudinal section, a further option for establishing contact between a conductor coming from an inverter module 10 and a bar-shaped conductor 4. In this case screwed pressed and/or welded connections are possible between conductor and connecting element 18 and also between connecting element 18 and bar-shaped conductor 4.

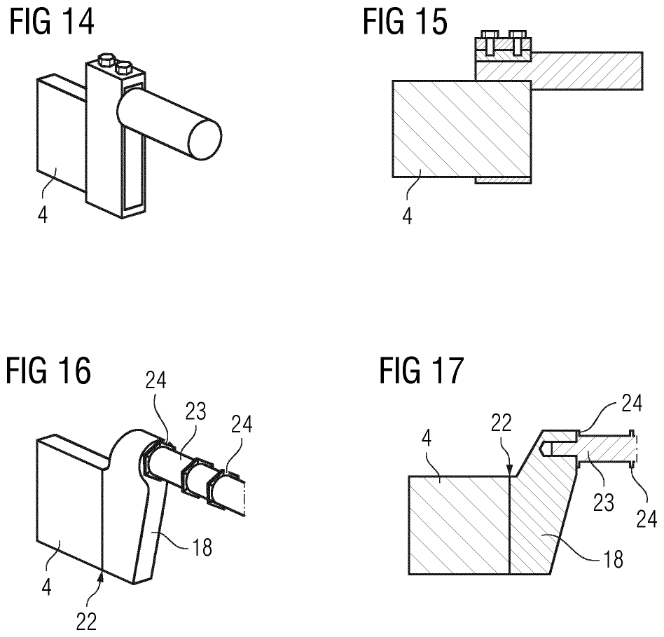

FIG. 14 and FIG. 15 show, in a perspective diagram and in a basic diagram of a longitudinal section, a further option for establishing contact between a conductor coming from an inverter module 10 and a bar-shaped conductor 4. In this case contact between the partners to be contacted is made via a screw-press connection.

FIG. 16 and FIG. 17 show, in a perspective diagram and in a basic diagram of a longitudinal section, a preferred option for establishing contact between a conductor coming from an inverter module 10 and a bar-shaped conductor 4, in that an inventive weld seam 22 is provided there.

1.-10. (canceled)

11. A rotary dynamoelectric machine, comprising:
a stator comprising a magnetically conductive element and a winding system arranged in the magnetically conductive element and including bar-shaped conductors arranged in grooves of the magnetically conductive element, wherein each said bar-shaped conductor has a first end which protrudes from a corresponding one of the grooves on an end face side of the magnetically conductive element, said bar-shaped conductor including a number of partial conductors per groove or being designed in one piece;
a rotor separated from the stator by an air gap;
an inverter module;
a connecting element connected to the first end of the bar-shaped conductor;
a contact element with a stud for establishing an electrically low-impedance contact between the first end of the bar-shaped conductor and the connecting element to the inverter module, or a contact stud designed for extension via a female/male contact to a further said contact stud for contacting the connecting element so as to enable a connection of a plurality of said inverter module axially behind one another to the connecting element; and
a short circuit ring designed to combine a second end of the bar-shaped conductors on another end face side of the magnetically conductive element of the stator.

12. The rotary dynamoelectric machine of claim 11, wherein the partial conductors of the bar-shaped conductor are twisted in the groove.

13. The rotary dynamoelectric machine of claim 11, further comprising cooling panels provided between two or more of said inverter module arranged axially behind each other, said cooling panels having at least one section in thermally conductive contact with a neighboring one of the inverter modules.

14. The rotary dynamoelectric machine of claim 11, wherein the magnetically conductive element is a laminated core of the stator.

15. The rotary dynamoelectric machine of claim 11, for use in an industrial environment.

16. The rotary dynamoelectric machine of claim 11, for use in a booster, compressor or pump.

17. A method for manufacturing a stator of a rotary dynamoelectric machine, the method comprising:
manufacturing a magnetically conductive element;
contacting a connecting element at a first axial end of a bar-shaped conductor of a winding system;
axially inserting the bar-shaped conductor in a groove of the magnetically conductive element;
contacting a short circuit ring at a second end of the bar-shaped conductor; and
axially placing an inverter module on the connecting element in contact with the bar-shaped conductor so as to establish a contact via a contact element between the connecting element and the inverter module.

18. The method of claim 17, wherein the connecting element is contacted at the first axial end of the bar-shaped conductor by butt joint welding.

19. The method of claim 17, wherein the connecting element is contacted at the first axial end of the bar-shaped conductor in advance.

20. The method of claim 17, further comprising fixing the connecting element and the bar-shaped conductor by clamping jaws during contacting.

21. The method of claim 17, further comprising removing an existing insulation material on the bar-shaped conductor and/or the connection element in at least one region of a joining point.

22. The method of claim 21, wherein the insulation material is burnt away.
